(19) United States
(12) Patent Application Publication
(10) Pub. No.: US 2025/0005323 A1
(43) Pub. Date: Jan. 2, 2025

(54) MEMORY AUTO TUNING

(71) Applicant: INTERNATIONAL BUSINESS MACHINES CORPORATION, Armonk, NY (US)

(72) Inventors: NAIJIE LI, BEIJING (CN); Peng Hui Jiang, BEIJING (CN); Bao Zhang, Beijing (CN); Jing Lu, Beijing (CN); Ming Ran Liu, Beijing (CN); Yuan Zhai, Beijing (CN); Dong Hui Liu, BEIJING (CN)

(21) Appl. No.: 18/216,698

(22) Filed: Jun. 30, 2023

(51) Int. Cl. G06N 3/045; G06N 3/092

(52) U.S. Cl. CPC G06N 3/045; G06N 3/092

(57) ABSTRACT

A method, system, and computer program product that is configured to: receive at least one workload of a mixed addressing mode application; classify the at least one workload with artificial intelligence (AI) including a support vector machine (SVM) algorithm; match at least one agent to the at least one workload based on a workload class and tuning policies; execute workload polices of the at least one workload based on the workload class and the tuning policies; evaluate a transaction per second (TPS) and response time of the at least one workload; calculate a reward of the at least one workload; and train a plurality of models based on historical data corresponding to the evaluated TPS, the evaluated response time, and the calculated reward.

### BACKGROUND

Aspects of the present invention relate generally to memory auto tuning and, more particularly, to memory tuning for mixed addressing mode programs.

Integrating and connecting traditional and modern workloads is key for current applications. For example, common business oriented language (COBOL) transactions and procedural, imperative computer programming language (PL/I) data handling programs correspond with 31-bit applications. In another example, Java services and python machine learning pipelines correspond with 64-bit applications.

### SUMMARY

In a first aspect of the invention, there is a computer-implemented method including: receiving, by a processor set, at least one workload of a mixed addressing mode application; classifying, by the processor set, the at least one workload using artificial intelligence (AI) including a support vector machine (SVM); matching, by the processor set, at least one agent to the at least one workload based on a workload class and tuning policies; executing, by the processor set, workload polices of the at least one workload based on the workload class and the tuning policies; evaluating, by the processor set, a transaction per second (TPS) and response time of the at least one workload; calculating, by the processor set, a reward of the at least one workload; and training a plurality of models based on historical data corresponding to the evaluated TPS, the evaluated response time, and the calculated reward.

In another aspect of the invention, there is a computer program product including one or more computer readable storage media having program instructions collectively stored on the one or more computer readable storage media. The program instructions are executable to: receive at least one workload of a mixed addressing mode application; classify the at least one workload using a support vector machine (SVM) algorithm; match at least one agent to the at least one workload based on a workload class and tuning policies; execute workload polices of the at least one workload based on the workload class and the tuning policies; evaluate a transaction per second (TPS) and response time of the at least one workload; calculate a reward of the at least one workload; and train a plurality of models based on historical data corresponding to the evaluated TPS, the evaluated response time, and the calculated reward.

In another aspect of the invention, there is a system including a processor set, one or more computer readable storage media, and program instructions collectively stored on the one or more computer readable storage media. The program instructions are executable to: receive at least one workload of a mixed addressing mode application; classify the at least one workload using a support vector machine (SVM) algorithm; match at least one agent to the at least one workload based on a workload class and tuning policies; execute workload polices of the at least one workload based on the workload class and the tuning policies; evaluate a transaction per second (TPS) and response time of the at least one workload; calculate a reward of the at least one workload; and train a plurality of models based on historical data corresponding to the evaluated TPS, the evaluated response time, and the calculated reward. The at least one agent models a class policy corresponding to the workload class by utilizing a reinforcement learning algorithm based on demand factors and supply factors.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment of a memory auto tuning server in accordance with aspects of the present invention.

FIG. 3 shows a flowchart of an exemplary method of the memory auto tuning server in accordance with aspects of the present invention.

FIG. 4 shows workload classification tables in accordance with aspects of the present invention.

FIG. 5 shows an action factor table in accordance with aspects of the present invention.

FIG. 6 shows a block diagram of an exemplary environment of an agent module in accordance with aspects of the present invention.

FIG. 7 shows a block diagram of another exemplary embodiment of the memory auto tuning server in accordance with aspects of the present disclosure.

FIG. 8 shows a flowchart of another exemplary method of the memory auto tuning server in accordance with aspects of the present invention.

### DETAILED DESCRIPTION

In a first aspect of the invention, there is a computer-implemented method including: receiving, by a processor set, at least one workload of a mixed addressing mode application; classifying, by the processor set, the at least one workload using artificial intelligence (AI) including a support vector machine (SVM); matching, by the processor set, at least one agent to the at least one workload based on a workload class and tuning policies; executing, by the processor set, workload polices of the at least one workload based on the workload class and the tuning policies; evaluating, by the processor set, a transaction per second (TPS) and response time of the at least one workload; calculating, by the processor set, a reward of the at least one workload; and training a plurality of models based on historical data corresponding to the evaluated TPS, the evaluated response time, and the calculated reward. In particular, embodiments may improve interoperability between mixed addressing modes of an application.

The computer-implemented method may also include training an application classification model by further selecting from a group consisting of historical profiling data, performance data, an initial model training run, demand factors, supply factors, and information from at least one application; and classifying the at least one workload using the AI including the SVM algorithm, and the trained application classification model. In particular, embodiments may improve training of an application classification model to improve classifying the at least one workload.

The computer-implemented method may also include training a memory tune action model based on a class policy corresponding to the workload class; and determining the tuning policies using the trained memory tune action model. In particular, embodiments may improve training of a memory tune action model to improve tuning policies.

The computer-implemented method may also include the class policy corresponding to the workload class including demand factors and supply factors of at least one application a service level agreement (SLA). In particular, embodiments may improve specificity of the class policy with regards to at least one application and a service level agreement (SLA).

The computer-implemented method may also include the mixed addressing mode application including a first bit program and a second bit program which is different from the first bit program. In particular, embodiments may improve specificity of the mixed addressing mode application with regards to specific programs that are included in the mixed addressing mode application.

The computer-implemented method may also include the first bit program including a 31-bit program. In particular, embodiments may improve specificity with regards to the first bit program.

The computer-implemented method may also include the 31-bit program including a common business oriented language (COBOL) program. In particular, embodiments may improve specificity with regards to the 31-bit program.

The computer-implemented method may also include the second bit program including a 64-bit program. In particular, embodiments may improve specificity with regards to the second bit program.

The computer-implemented method may also include the 64-bit program including a Java program. In particular, embodiments may improve specificity with regards to the 64-bit program.

The computer-implemented method may also include the at least one agent modeling a class policy corresponding to the workload class. In particular, embodiments may improve modeling of a class policy corresponding to a workload class.

The computer-implemented method may also include the at least one agent modeling the class policy corresponding to the workload class by utilizing a reinforcement learning algorithm based on demand factors and supply factors. In particular, embodiments may improve modeling of the class policy corresponding to the workload class by utilizing a reinforcement learning algorithm.

In another aspect of the invention, there is a computer program product including one or more computer readable storage media having program instructions collectively stored on the one or more computer readable storage media. The program instructions are executable to: receive at least one workload of a mixed addressing mode application; classify the at least one workload using a support vector machine (SVM) algorithm; match at least one agent to the at least one workload based on a workload class and tuning policies; execute workload polices of the at least one workload based on the workload class and the tuning policies; evaluate a transaction per second (TPS) and response time of the at least one workload; calculate a reward of the at least one workload; and train a plurality of models based on historical data corresponding to the evaluated TPS, the evaluated response time, and the calculated reward. In particular, embodiments may improve interoperability between mixed addressing modes of an application.

The computer-implemented method may also include training an application classification model by further selecting from a group consisting of historical profiling data, performance data, an initial model training run, demand factors, supply factors, and information from at least one application; and classifying the at least one workload using the SVM algorithm and the trained application classification model. In particular, embodiments may improve training of an application classification model to improve classifying the at least one workload.

The computer-implemented method may also include training a memory tune action model based on a class policy corresponding to the workload class; and determining the tuning policies based on the trained memory tune action model. In particular, embodiments may improve training of a memory tune action model to improve tuning policies.

The computer-implemented method may also include the mixed addressing mode application including a first bit program and a second bit program which is different from the first bit program. In particular, embodiments may improve specificity of the mixed addressing mode application with regards to specific programs that are included in the mixed addressing mode application.

The computer-implemented method may also include at least one agent modeling a class policy corresponding to the workload class. In particular, embodiments may improve modeling of a class policy corresponding to a workload class.

The computer-implemented method may also include the at least one agent modeling the class policy corresponding to the workload class by utilizing a reinforcement learning algorithm based on demand factors and supply factors. In particular, embodiments may improve modeling of the class policy corresponding to the workload class by utilizing a reinforcement learning algorithm.

In another aspect of the invention, there is a system including a processor set, one or more computer readable storage media, and program instructions collectively stored on the one or more computer readable storage media. The program instructions are executable to: receive at least one workload of a mixed addressing mode application; classify the at least one workload using a support vector machine (SVM) algorithm; match at least one agent to the at least one workload based on a workload class and tuning policies; execute workload polices of the at least one workload based on the workload class and the tuning policies; evaluate a transaction per second (TPS) and response time of the at least one workload; calculate a reward of the at least one workload; and train a plurality of models based on historical data corresponding to the evaluated TPS, the evaluated response time, and the calculated reward. The at least one agent models a class policy corresponding to the workload class by utilizing a reinforcement learning algorithm based on demand factors and supply factors. In particular, embodiments may cause improved interoperability between mixed addressing modes of an application.

The computer-implemented method may also include the mixed addressing mode application including a first bit program and a second bit program which is different from the first bit program. In particular, embodiments may improve specificity of the mixed addressing mode application with regards to specific programs that are included in the mixed addressing mode application.

The computer-implemented method may also include the demand factors and the supply factors corresponding with at least one application and a service level agreement (SLA). In particular, embodiments may improve specificity with regards to the demand factors and the supply factors.

Aspects of the present invention relate generally to memory auto tuning and, more particularly, to memory tuning for addressing mode M and N mixed programs. The different addressing modes are referred to herein generically as AMODE M and AMODE N, where M and N are different applications. For instance, in example embodiments, a program associated with addressing mode AMODE M can be a 31-bit program and a program associated with addressing mode AMODE N can be a 64-bit program, or vice-versa. While example embodiments can be described with respect to interoperability between 31-bit and 64-bit programs, it should be appreciated that the programs can be any N-bit and M-bit programs as long as N and M represent different applications (i.e., different addressing mode applications). In an example embodiment, a mixed addressing mode application includes a first bit program and a second bit program which is different from the first bit program.

Embodiments of the present invention enable tuning of hybrid workloads, such as mixed languages, mixed addressing modes (i.e., AMODES) including 31-bit and 64-bit programs, and mixed memory usage patterns in one application. Embodiments of the present invention provide specific options from a different addressing mode than a current addressing mode (e.g., provide specific Java options, which correspond with a 64-bit program from a COBOL side, which corresponds with a 31-bit program). Embodiments of the present invention define features for mixed addressing mode applications, group the mixed addressing mode applications into different classes, and establish specific models for memory demands and supply patterns which correspond with the different classes. Embodiments of the present invention provide design tuning and evaluation of policies to make tuning decisions automatically based on policies which take into account workload attributes, system states, and service level agreement (SLA) indicators (e.g., millions of instructions per second, MIPS and/or transactions per second, TPS) to meet workload business goals. Embodiments of the present invention evaluate tuning outcomes based on workload attributes and SLA indicators. Embodiments of the present invention also leverage artificial intelligence (AI) and machine learning (ML) algorithms, such as reinforcement learning, support vector machine (SVM), and convolution neural networks (CNN). However, embodiments of the present invention are not limited to reinforcement learning, SVM, and CNN, such that users can use all or part of the factors and/or methods defined in aspects of the present invention for running mixed applications with other AI and ML algorithms. Embodiments of the present invention provide a proactive and interactive storage tuning method for mixed addressing mode applications.

Embodiments of the present invention provide a proactive and interactive storage tuning method to manage cross addressing mode applications (i.e., AMODE M is less than AMODE N). In this example, M corresponds with a 31-bit application and N corresponds with a 64-bit application. Conventional systems require users to identify the most active applications and adjust storage options manually when a bottleneck is identified in mixed applications. Further, conventional systems apply tuning methods to an entire system, which may not be suitable for specific applications. Conventional systems only provide options from an initial program and cannot specify options from a different addressing mode.

Embodiments of the present invention provide memory tuning for addressing mode M and N mixed programs, in which M corresponds with a 31-bit application and N corresponds with a 64-bit application. Accordingly, implementations of aspects of the present invention provide an improvement (i.e., technical solution) to a problem arising in the technical field of mixed addressing mode applications. In particular, embodiments of the present invention include defining features for mixed addressing mode applications, grouping the mixed addressing mode applications into different classes, and establishing specific models for each class. Embodiments of the present invention also include design tuning and evaluating policies by taking into account workload attributes, system states, and SLA indicators. Also, embodiments of the present invention may not be performed mentally or may not be performed in a human mind because aspects of the present invention leverage AI algorithms, such as reinforcement learning and CNN, to address mixed addressing modes. Further, these implementations of the present invention improve the functioning of the computer by addressing memory bottlenecks for mixed addressing mode applications in an automated and iterative method.

Implementations of the invention are necessarily rooted in computer technology. For example, the step of classifying at least one workload using a support vector machine (SVM) algorithm is computer-based and cannot be performed in the human mind. Training and using a machine learning model and an artificial neural network are, by definition, performed by a computer and cannot practically be performed in the human mind (or with pen and paper) due to the complexity and massive amounts of calculations involved. For example, the support vector machine (SVM) algorithm may perform classification and regression on linear and non-linear data by finding complex relationship between input data. In particular, an SVM algorithm may perform classification and regression on a large amount of data with thousands of features to train the model such that the model generates an output in real time (or near real time). Given the scale and complexity of performing classification and regression on the large amount of data, it is simply not possible for the human mind, or for a person using pen and paper, to perform the number of calculations involved in training and/or using a machine learning model and an artificial neural network.

Aspects of the present invention include a method, system, and computer program product for providing a proactive interactive storage tuning mode to manage cross addressing mode applications. For example, a computer-implemented method includes: tuning by taking into consideration AMODE M and AMODE N applications; and handling an M/N correlation issue by first tuning AMODE M application then tuning AMODE N application in a tuning sequence, where AMODE M factors focus on virtual memory usage and AMODE N factors focus on real memory usage. In embodiments, the tuning of AMODE M and AMODE N applications in a memory is based on class policies and workload policies related to the AMODE M and AMODE N application in the memory. The computer-implemented method also includes balancing memory usages for M/N mixed workloads by considering AMODE M and AMODE N factors together. For example, the AMDOE M factors are factors related to virtual memory usage and the AMODE N factors are factors related to real memory usage. The computer-implemented method includes defining features and establishing a classification model to make tuning actions for AMODE M and AMODE N applications by utilizing profiling, an initial training run, and other performance data. The computer-implemented method includes classifying workloads for different M/N mixed cases to improve an accuracy of a tuning decision; and providing varieties of tuning policies for each model and providing tuning actions based on M/N memory usage patterns (i.e., work classes). The computer-implemented method includes: meeting business goals of the mixed addressing modes by taking into account workload memory requirements, workload memory fragmentation, system saturation factors (e.g., CPU usage, MIPS, etc.), and SLA indicators (e.g., TPS); and designing a score policy to guide tuning actions based on the workload memory requirements, workload memory fragmentation, system saturation factors, and SLA indicators. The computer-implemented method further includes designing an evaluation policy of the outcomes to assist further tuning on a workload end.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as memory auto tuning code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

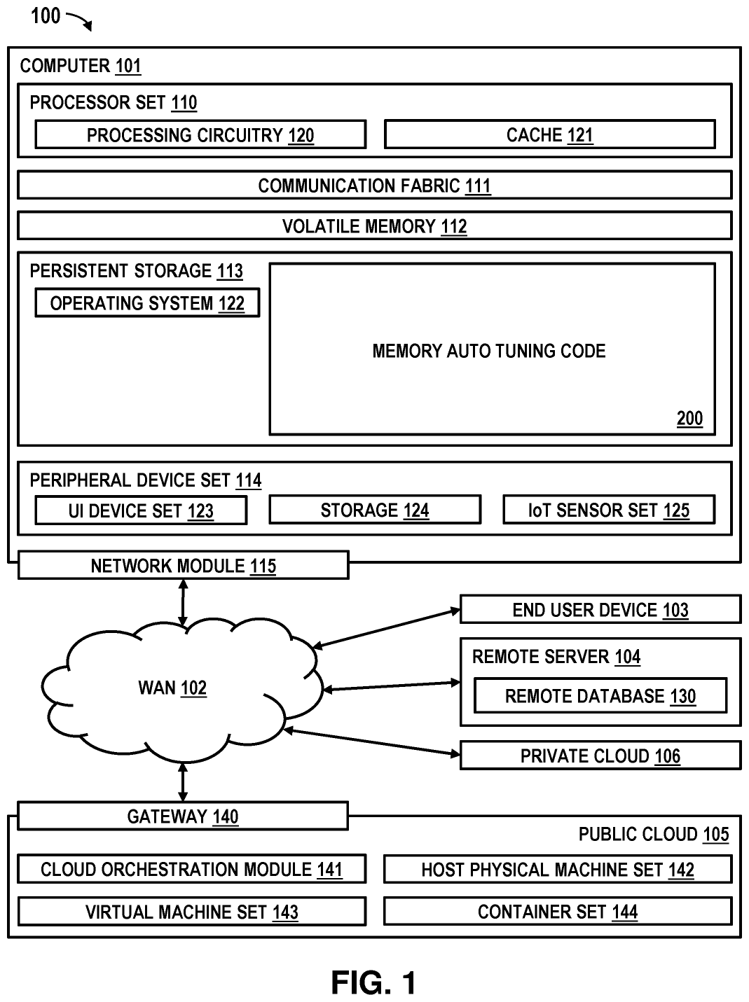

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

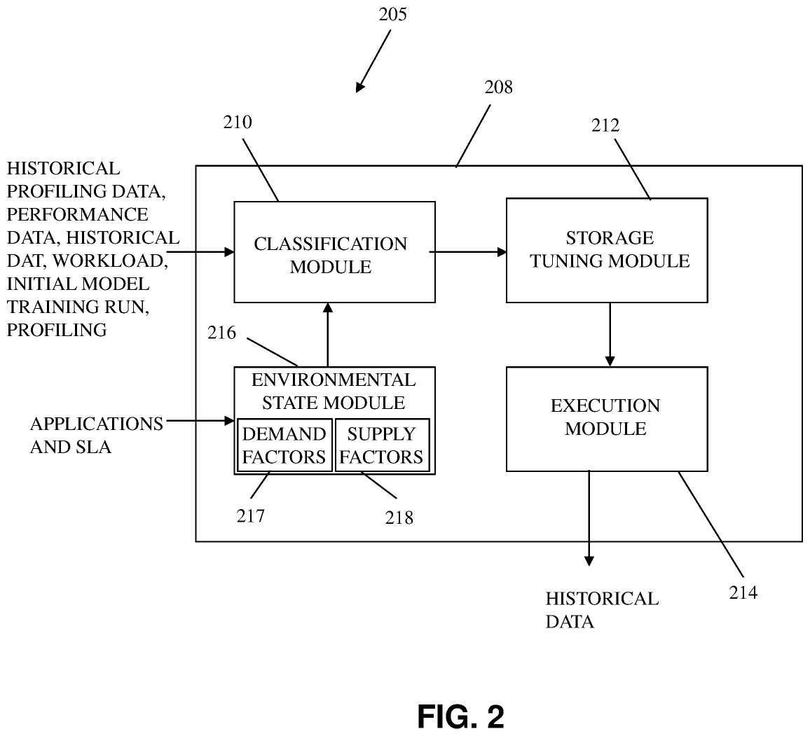

FIG. 2 shows a block diagram of an exemplary environment 205 in accordance with aspects of the invention. In embodiments, the environment 205 includes a memory auto tuning server 208, which may comprise one or more instances of the computer 101 of FIG. 1. In other examples, the memory auto tuning server 208 comprises one or more virtual machines or one or more containers running on one or more instances of the computer 101 of FIG. 1.

In embodiments, the memory auto tuning server 208 of FIG. 2 comprises a classification module 210, a storage tuning module 212, an execution module 214, and an environmental state module 216, each of which may comprise modules of the code of block 200 of FIG. 1. In embodiments, the environmental state module 216 further includes demand factors 217 and supply factors 218. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The memory auto tuning server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, and in accordance with aspects of the invention, the classification module 210 receives at least one workload (e.g., at least one transaction) and classifies the at least one workload (e.g., at least one transactions) for a mixed addressing mode application using an application classification model. In particular, the classification module 210 trains the application classification model for a mixed addressing mode application using at least one of historical profiling data, performance data, an initial model training run, historical data, demand factors, supply factors, information from applications, etc. In embodiments, the classification module 210 uses a computer-implemented classification method to classify the at least one workload. The computer-implemented classification method may comprise classifying using a support vector machine (SVM) algorithm, for example. For example, the classification module 210 receives information from applications (e.g., an initial model training run) and historic profiling data to generate an initial static history data which includes a memory demand, memory supply, response time for training the application classification model and classifies the at least one workload for a mixed addressing mode application using the trained application classification model.

In embodiments, the classification module 210, which includes the application classification model, classifies the at least one workload for a mixed addressing mode application based on the demand factors 217 from the environmental state module 216. In particular, the demand factors 217 defined for each workload include at least the following Factors 1-4:

| | |
|---|---|
| 31bit part: [#req] system storage allocation, fragmentation level | (Factor 1); |
| 64bit part: [#req] system storage allocation, TLB miss level | (Factor 2); |
| Co-related: [#req] demand factor to present the co-relation level since | |
| they are calling each other in a same thread | (Factor 3); |
| Priority: [#opt] adjust demand based on workload priority | (Factor 4). |

In Factors 1-4 above, TLB refers to a translation lookaside buffer (TLB), #req refers to a required factor, and #opt refers to an optional factor. However, embodiments are not limited to these examples, and the classification module 210 may classify workloads for the mixed addressing mode application based on other demand factors 217.

In embodiments, the classification module 210 uses the application classification model to classify at least one workload for the mixed addressing mode application based on the supply factors 218 from the environmental state module 216. In particular, the supply factors 218 defined for each workload includes at least the following Factors 5 and 6:

| | |
|---|---|
| 31-bit memory supply measured by a virtual memory saturation level | (Factor 5); |
| 64-bit memory supply measured by a real memory saturation level | (Factor 6). |

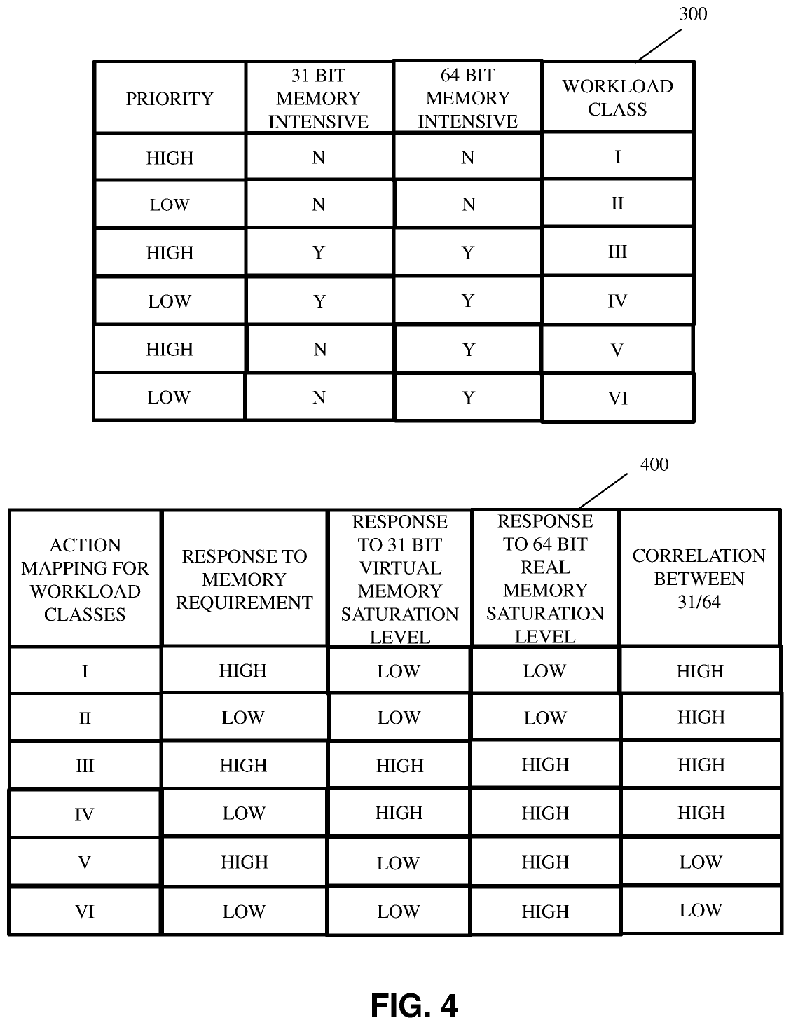

In Factors 5 and 6 above, saturation levels may correspond with levels from saturation factors, such as CPU usage, MIPS, etc., for at least one of the virtual memory and the real memory. However, embodiments are not limited to these examples, and the classification module 210 may classify workloads for the mixed addressing mode application based on other supply factors 218. In further embodiments, the classification module 210 populates workload classification tables for classification based on the demand factors 217 and the supply factors 218 and sends the workload classification tables to the storage tuning module 212. For example, the classification module 210 populates the workload classification tables with information regarding the Workload Class I, Workload Class II, Workload Class III, Workload Class IV, Workload Class V, and Workload Class VI. The workload classification tables (e.g., a first workload classification table 300 and a second workload classification table 400) are described herein with respect to FIG. 4.

In embodiments, the storage tuning module 212 comprises an agent for every class policy. In particular, an agent models a corresponding class policy, is matched to at least one workload, and sends output to the execution model 214 for tuning a memory and executing workload policies of the mixed addressing mode application. In embodiments, the agent comprises a script for modeling the corresponding class policy, matching to at least one workload, and sending an output to the execution model 214. In an example, the storage tuning module 212 comprises a first agent, a second agent, a third agent, a fourth agent, a fifth agent, and a sixth agent which correspond with a Class 1 Policy, a Class 2 Policy, a Class 3 Policy, a Class 4 Policy, a Class 5 Policy, and a Class 6 Policy. In further embodiments, each of the agents model a corresponding class policy based on the workload classification tables and tuning policies. In addition, each of the agents are matched to the at least one workload based on the workload classification tables (i.e., a workload class) and tuning policies. Then, each of the agents send outputs to the execution model 214 for tuning the memory and executing workload policies of the mixed addressing mode application. In other embodiments, after the storage tuning module 212 models the memory tune action model based on the workload classification tables and tuning policies, the storage tuning module 212 sends outputs from the memory tune action model to the execution module 214 for tuning the memory and executing workload policies of the mixed addressing mode application.

In FIG. 2, and in accordance with aspects of the invention, the storage tuning module 212 models a memory tune action model based on the demand factors 217 and the supply factors 218. In particular, the storage tuning module 212 receives the workload classification tables from the classification module 210 and models the memory tune action model based on the workload classification tables and tuning policies. In embodiments, the storage tuning module 212 also includes Class 1 policies, Class 2 policies, Class 3 policies, Class 4 policies, Class 5 policies, Class 6 policies, and/or Class n policies (e.g., n being an integer for the last policy). In further embodiments, the storage tuning module 212 models the memory tune action model based on the following Class 1 policy for Workload Class I:

Mapp_actions = Mvirtmem_need_factor(log) − Mvirtmem_syssaturation_factor;
Napp_actions = Mapp_actions * 70% + (Nrealmem_need_factor −
Nrealmem_sysaturation_factor) * 30%;
Mvirtmem_need_factor = sigmoid (Mmem_fall_through_lvl);
Mvirtmem_frag_factor = sigmoid (Mvirtmem_frag_percent);
Mvirtmem_syssaturation_factor = sigmod (Mvirtmem_syssaturation_lvl).
(Class 1 policy for Workload Class I).

In the Class 1 policy for Workload Class I, i.e., high priority workload, both AMODE M and AMODE N side are non-memory intensive. In embodiments, the AMODE M side is a portion of the workload which corresponds with the M-bit programs and the AMODE N side is a portion of the workload which corresponds with the N-bit programs within the mixed addressing mode application. For example, in the Class 1 policy for Workload Class I, the user uses 64-bit Java to expose a COBOL query workload as a micro service. In the tuning policies for Workload Class I, Mapp_actions calculates the application actions for the AMODE M side based on the memory virtual memory system saturation factor (i.e., Mvirtmem_syssaturation_factor) subtracted from the memory virtual memory need factor in log scale (i.e., Mvirtmem_need_factor (log)). Further, the Napp_actions calculates the application actions for the AMODE N side based on the Mapp_actions multiplied by 70% and adding the multiplication of 30% by a subtraction of the real memory system saturation factor from the real memory need factor (i.e., Nrealmem_need_factor-Nrealmem_syssaturation_factor). In the Workload Class I, sigmoid refers to a sigmoid function which normalizes the data for neural networks such that Mvirtmem_need_factor calculates the virtual memory need factor for the AMODE M side based on the sigmoid function of the memory fall through level. Further, in the Workload Class I, the Mvirtmem_frag_factor calculates the virtual memory fragmentation factor for the AMODE M side based on the sigmoid identification function of the virtual memory fragmentation percentage. The Mvirtmem_syssaturation factor calculates the virtual memory saturation factor for the AMODE M side based on the sigmoid function of the virtual memory system saturation level.

The storage tuning module 212 models the memory tune action model based on the following Class 2 policy for Workload Class II:

Mapp_actions = Mvirtmem_need_factor(sigmoid) − Mvirtmem_syssaturation_factor;
Napp_actions = Mapp_actions * 70% + (Nrealmem_need_factor −
Nrealmem_sysaturation_factor) * 30%.
(Class 2 policy for Workload Class II).

In the Class 2 policy for Workload Class II, i.e., low priority workload, both AMODE M and AMODE N side are non-memory intensive. For example, in the Class 2 policy for Workload Class II, the user uses 64-bit Java to expose a COBOL query workload as a micro service. In the tuning policies for Workload Class II, Mapp_actions calculates the application actions for the AMODE M side based on the memory virtual memory system saturation factor (i.e., Mvirtmem_syssaturation_factor) subtracted from the memory virtual memory need factor using a sigmoid scale (i.e., Mvirtmem_need_factor (sigmoid)). Further, the Napp_actions calculates the application actions for the AMODE N side based on the Mapp_actions multiplied by 70% and adding the multiplication of 30% by a subtraction of the real memory system saturation factor from the real memory need factor (i.e., Nrealmem_need_factor-Nrealmem_syssaturation_factor). In the Workload Class II, sigmoid refers to the sigmoid function for neural networks which normalizes the data.

The storage tuning module 212 models the memory tune action model based on the following Class 3 policy for Workload Class III:

Mapp_actions = Mvirtmem_need_factor(log) − Mvirtmem _frag_factor * 50% −
Mvirtmem_syssaturation_factor * 50%;
Napp_actions = Mapp_actions * 50% + (Nrealmem_need_factor −
Nrealmem_frag_factor * 50% − Nrealmem_sysaturation_factor * 50%) * 50%.
(Class 3 policy for Workload Class III).

In the Class 3 Policy for Workload Class III, i.e., high priority workload, both AMODE M and AMODE N side are memory intensive. For example, in the Class 3 Policy for Workload Class III, the user keeps existing 31-bit COBOL side logic unchanged, and adds new business logic in 64-bit Java sides, so both sides become complicated. In the tuning policies for Workload Class III, Mapp_actions calculates the application actions for the AMODE M side based on the memory virtual memory system saturation factor multiplied by 50% (i.e., Mvirtmem_syssaturation_factor) subtracted from the memory virtual memory fragmentation factor multiplied by 50% (i.e., Mvirtmem_frag_factor) and further subtracted from the memory virtual memory need factor using a log scale multiplied by 50% (i.e., Mvirtmem_need_factor (log)). Further, the Napp_actions calculates the application actions for the AMODE N side based on the Mapp_actions multiplied by 50% and adding the multiplication of 50% by a subtraction of the real memory system saturation factor multiplied by 50% from the real memory fragmentation factor multiplied by 50% and further subtracted from the real memory need factor (i.e., Nrealmem_need_factor*50%-Nrealmen_frag_factor*50%-Nrealmem_syssaturation_factor*50%).

The storage tuning module 212 models the memory tune action model based on the following Class 4 Policy for Workload Class IV:

Mapp_actions = Mvirtmem_need_factor(sigmoid) − Mvirtmem_frag_factor * 50% −
Mvirtmem_syssaturation_factor * 50%;
Napp_actions = Mapp_actions * 50% + (Nrealmem_need_factor −
Nrealmem_frag_factor * 50% − Nrealmem_sysaturation_factor * 50%) * 50%.
(Class 4 Policy for Workload Class IV).

In the Class 4 Policy for Workload Class IV, i.e., low priority workload, both AMODE M and AMODE N side are memory intensive. For example, in the Class 4 Policy for Workload Class IV, the user keeps existing 31-bit COBOL side logic unchanged, and adds new business logic in 64-bit Java sides, so both sides become complicated. In the tuning policies for Workload Class IV, Mapp_actions calculates the application actions for the AMODE M side based on the memory virtual memory system saturation factor multiplied by 50% (i.e., Mvirtmem_syssaturation_factor) subtracted from the memory virtual memory fragmentation factor multiplied by 50% (i.e., Mvirtmem_frag_factor) and further subtracted from the memory virtual memory need factor using a sigmoid scale multiplied by 50% (i.e., Mvirtmem_need_factor (scale)). Further, the Napp_actions calculates the application actions for the AMODE N side based on the Mapp_actions multiplied by 50% and adding the multiplication of 50% by a subtraction of the real memory system saturation factor multiplied by 50% from the real memory fragmentation factor multiplied by 50% and further subtracted from the real memory need factor (i.e., Nrealmem_need_factor-Nrealmen_frag_factor*50%-Nrealmem_syssaturation_factor*50%).

The storage tuning module 212 models the memory tune action model based on the following Class 5 Policy for Workload Class V:

Mapp_actions = Mvirtmem_need_factor(log) − Mvirtmem_syssaturation_factor;
Napp_actions = Mapp_actions * 30% + (Nrealmem_need_factor −
Nrealmem_frag_factor * 50% − Nrealmem_sysaturation_factor * 50%) * 70%.
(Class 5 Policy for Workload Class V).

In the Class 5 Policy for Workload Class V, i.e., high priority workload, only AMODE M side is memory intensive. For example, in the Class 5 Policy for Workload Class V, the user uses 64-bit python to ingest data from existing 31-bit COBOL workloads to construct a machine learning pipeline. In the tuning policies for Workload Class V, Mapp_actions calculates the application actions for the AMODE M side based on the memory virtual memory system saturation factor (i.e., Mvirtmem_syssaturation_factor) subtracted from the memory virtual memory need factor using a log scale multiplied by 50% (i.e., Mvirtmem_need_factor (log)). Further, the Napp_actions calculates the application actions for the AMODE N side based on the Mapp_actions multiplied by 30% and adding the multiplication of 70% by a subtraction of the real memory system saturation factor multiplied by 50% from the real memory fragmentation factor multiplied by 50% and further subtracted from the real memory need factor (i.e., Nrealmem_need_factor-Nrealmen_frag_factor*50%-Nrealmem_syssaturation_factor*50%).

The storage tuning module 212 models the memory tune action model based on the following Class 6 Policy for Workload Class VI:

Mapp_actions = Mvirtmem_need_factor(sigmoid) − Mvirtmem_syssaturation_factor;
Napp_actions = Mapp_actions * 30% + (Nrealmem_need_factor −
Nrealmem_frag_factor * 50% − Nrealmem_sysaturation_factor * 50%) * 70%.
(Class 6 Policy for Workload Class VI).

In the Class 6 Policy for Workload Class VI, i.e., low priority workload, only AMODE N side is memory intensive. For example, in the Class 6 Policy for Workload Class VI, the user uses 64-bit python to ingest data from existing 31-bit COBOL workloads to construct a machine learning pipeline. In the tuning policies for Workload Class VI, Mapp_actions calculates the application actions for the AMODE M side based on the memory virtual memory system saturation factor (i.e., Mvirtmem_syssaturation_factor) subtracted from the memory virtual memory need factor using a sigmoid scale multiplied by 50% (i.e., Mvirtmem_need_factor (sigmoid)). Further, the Napp_actions calculates the application actions for the AMODE N side based on the Mapp_actions multiplied by 30% and adding the multiplication of 70% by a subtraction of the real memory system saturation factor multiplied by 50% from the real memory fragmentation factor multiplied by 50% and further subtracted from the real memory need factor (i.e., Nrealmem_need_factor-Nrealmen_frag_factor*50%-Nrealmem_syssaturation_factor*50%). In the above classes, 30%, 70% and 50% are samples for percentages, which can be changed or tuned by users.

In FIG. 2, and in accordance with aspects of the invention, the execution module 214 tunes the memory based on the outputs from the memory tune action model in the storage tuning module 212 and executes workload policies of the at least workload of the mixed addressing mode application based on the tuning of the memory. The execution module 214 also performs an evaluation of the execution of the workload policies of the at least one workload of the AMODE application based on the tuning of the memory. In an example, the execution module 214 includes a plurality of transactions (e.g., transaction 1, transaction 2, . . . , transaction n), a runtime library, a system kernel, etc., for tuning the memory and executing and evaluating the workload policies of the at least one workload AMODE application based on the tuning of the memory. After the execution module 214 tunes the memory and executes the workload policies of the at least one workload, the execution module 214 sends the output of the execution to the historical data for refining the application classification model and the memory tune action model of the classification module 210 and the storage tuning module 212, respectively.

In embodiments, the execution module 214 evaluates the transaction per second (TPS) for each transaction and the response time of the at least one workload based on Formula 1 and Formula 2 below:

$${F}_{TPS} = \{ {( {TPS}_{r} / {TPS}_{t} )}^{m} for {TPS}_{r} \leq {TPS}_{t} , and {TPS}_{r} > {TPS}_{t} \} ; \qquad ( Formula 1 ) .$$

$${F}_{res} = \{ {[ 1 - ( ( {restime}_{r} - {restime}_{t} ) / {restime}_{r} ) ]}^{n} for {restime}_{r} \geq {restime}_{t} , and 1 for {restime}_{r} < {restime}_{t} \} \qquad ( Formula 2 ) .$$

In Formula 1, F_{TPS} is a global factor for transaction per second (TPS), TPSₜ is a target TPS that corresponds with one of an SLA related target TPS and a system limit target TPS, TPSᵣ is a real TPS. In Formula 1, m is adjusted based on a sensitivity to a TPS of the system. In Formula 2, Fᵣₑₛ is a response time factor per transaction, restimeᵣ is a target response time, restimeₜ is a real response time. In Formula 2, n is adjusted based on a sensitivity to a response time of a transaction.

In embodiments, the execution module 214 calculates a reward based on F_{TPS}, Fᵣₑₛ, W_{TPS}(i), and Wᵣₑₛ(i). W_{TPS}(i) is a TPS factor weight for each workload class and Wᵣₑₛ(i) is a response time factor weight for each workload class. Thus, the reward is based on Formula 3 below:

$$Reward = {W}_{TPS} ( i ) * {F}_{TPS} + {W}_{res} ( i ) * {F}_{res} , \qquad ( Formula 3 ) .$$

$$in which {W}_{TPS} ( i ) + {W}_{res} ( i ) = 1$$

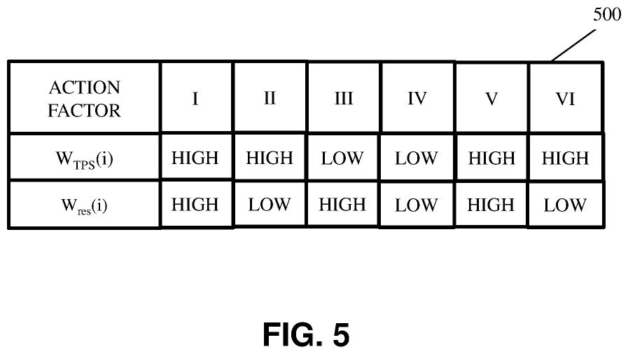

In Formula 3, W_{TPS}(i), Wᵣₑₛ(i), and n are adjusted based on the different workload classes. Further, based on a critical transaction, Wᵣₑₛ(i) is large since a transaction needs to be executed as fast as possible. For a non-critical transaction, the system of the embodiments makes decisions based on a whole system throughput. An action factor table 500 which includes the TPS factor weight W_{TPS}(i) and the response time factor weight Wᵣₑₛ(i) is described herein with respect to FIG. 5.

In FIG. 2, and in accordance with aspects of the invention, the environmental state module 216 receives applications and a service level agreement (SLA) and generates the demand factors 217 and the supply factors 218. For example, the environmental state module 216 generates demand factors 217, such as 31-bit factors, 64-bit factors, co-related factors, priority, etc. based on the applications and the SLA, and sends the demand factors 217 to the classification module 210. In another example, the environmental state module 216 generates supply factors 218, such as a 31-bit virtual memory saturation level, a 64-bit real memory saturation level, etc. based on the applications and the SLA, and sends the supply factors 218 to the classification module 210.

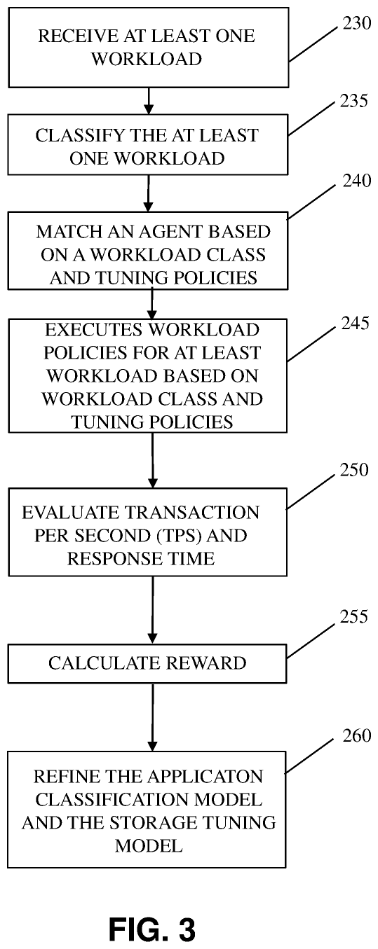

FIG. 3 shows a flowchart of an exemplary method of the memory auto tuning server in accordance with aspects of the present invention. Steps of the method may be carried out in the environment of FIG. 2 and are described with reference to elements depicted in FIG. 2.

At step 230, the system receives, at the classification module 210, at least one workload for a mixed addressing mode application using an application classification model. In embodiments and as described with respect to FIG. 2, the classification module 210 trains the application classification model using at least one of historical profiling data, performance data, an initial model training run, historical data, demand factors, supply factors, information from applications, etc. At step 235, the system classifies, at the classification module 210, the at least one workload for the mixed addressing mode application. In embodiments and as described with respect to FIG. 2, the classification module 210 classifies the at least one workload using a support vector machine (SVM) algorithm.

At step 240, the system matches, at the storage tuning module 212, an agent to the at least one workload based on the workload class of the workload classification tables and tuning policies. At step 245, the system executes, at the execution module 214, the workload policies of the at least one workload based on the workload class and tuning policies.

At step 250, the system evaluates, at the execution module 214, a transaction per second (TPS) and response time of the at least one workload. At step 255, the system calculates, at the execution module 214, a reward of the least one workload. At step 260, the system refines, at the classification module 210 and the storage tuning module 212, the application classification model and the memory tune action model, respectively based on the output of the execution of the workload policies of the at least one workload.

FIG. 4 shows exemplary workload classification tables in accordance with aspects of the present invention. In particular, the first workload classification table 300 has a first column which lists a priority, a second column which lists a 31-bit memory intensive, a third column which lists a 64-bit memory intensive, and a fourth column which lists a workload class. Further, the second workload classification table 400 has a first column which lists an action mapping for the workload classes, a second column which lists a response to a memory requirement, a third column which lists a response to a 31-bit virtual memory saturation level, a fourth column which lists a response to a 64-bit virtual memory saturation level, and a fifth column which lists a correlation between the 31-bit virtual memory saturation level/64-bit virtual memory saturation level.

FIG. 5 shows an exemplary action factor table in accordance with aspects of the present invention. In particular, the action factor table 500 has a first column which lists an action factor, a second column which lists an action mapping for workload class I, a third column which lists an action mapping for workload class II, a fourth column which lists an action mapping for workload class III, a fifth column which lists an action mapping for workload class IV, a sixth column which lists an action mapping for workload class V, a seventh column which lists an action mapping for workload class VI.

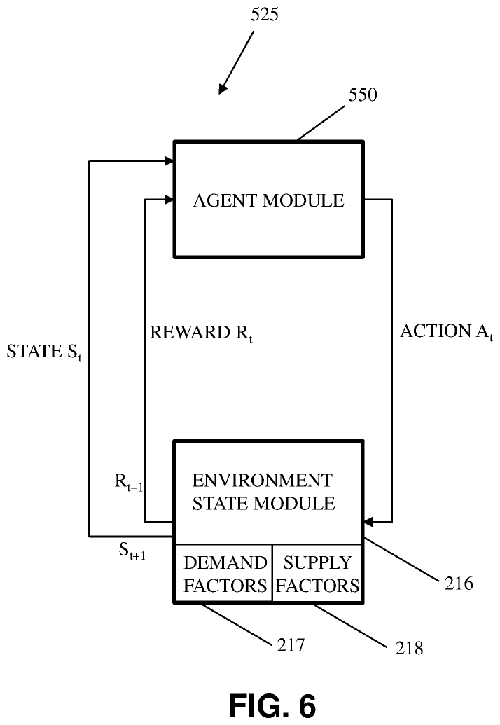

FIG. 6 shows a block diagram of an exemplary environment 525 of an agent module 550 in accordance with aspects of the present invention. In FIG. 6, an agent module 550 of the environment 525 includes at least one agent and the environment state module 216 includes the demand factors 217 and the supply factors 218. In FIG. 6, the at least one agent may be the same as the agent described above with respect to modeling a corresponding class policy, matching to at least one workload, and sending output to the execution model 214 for tuning a memory and executing workload policies of the mixed addressing mode application. Further, in embodiments, the agent module 550 may include a plurality of agents which each correspond with a different class policy. In FIG. 6, each of the at least one agent of the agent module 550 is assigned to at least one workload. In embodiments, the agent module 550 including the at least one agent sends an action Aₜ to the environment state module 216. The environment state module 216 then sends the demand factors 217 and the supply factors 218 as the state Sₜ to the agent module 550. The environment state module 216 also sends the transactions per second (TPS) and the response time Fᵣₑₛ as the reward Rₜ to the agent module 550. In FIG. 6, the reward Rₜ+1 and the state Sₜ+1 represents a next reward and a next state, respectively. In embodiments of FIG. 6, the agent module 550 and the environment state module 216 have a feedback loop which performs a reinforcement learning algorithm between the at least one agent of the agent module 550 and the environment state module 216. In particular, by using the reinforcement learning algorithm, the at least one agent module 550 updates a knowledge based on the reward and takes a next action based on the reward. In other embodiments, the action Aₜ, the state Sₜ can be normalized to vectors for use by a convolutional neural network (CNN) with the reward Rₜ being used to train a model of the CNN.

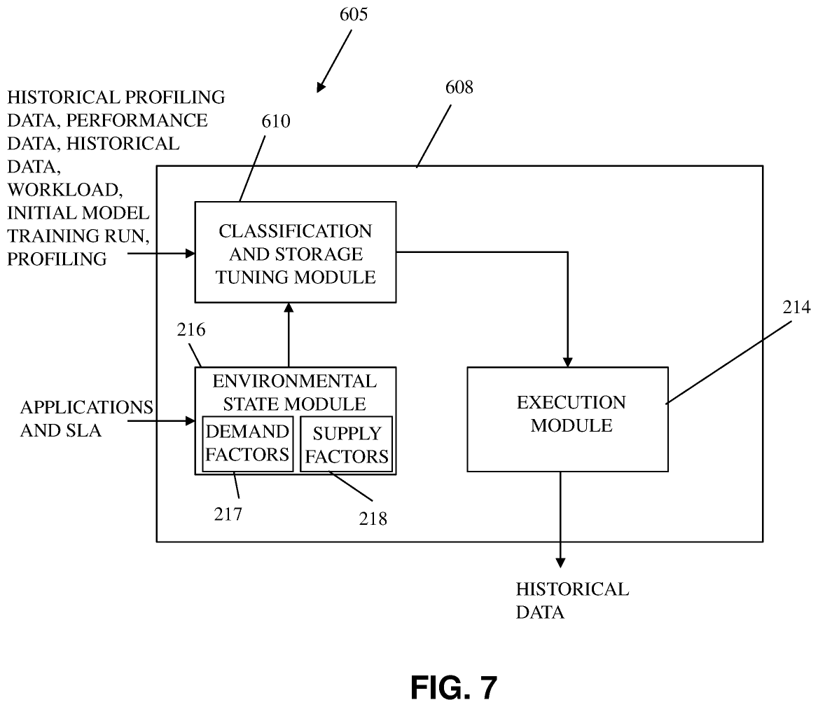

FIG. 7 shows a block diagram of another exemplary embodiment of the memory auto tuning server in accordance with aspects of the present disclosure. FIG. 7 shows a block diagram of an exemplary environment 605 in accordance with aspects of the invention. In embodiments, the environment 605 includes a memory auto tuning server 608, which may comprise one or more instances of the computer 101 of FIG. 1. In other examples, the memory auto tuning server 608 comprises one or more virtual machines or one or more containers running on one or more instances of the computer 101 of FIG. 1.

In embodiments, the memory auto tuning server 608 of FIG. 7 comprises a classification and storing tuning module 610, the execution module 214, and the environmental state module 216, each of which may comprise modules of the code of block 200 of FIG. 1. In embodiments, the environmental state module 216 further includes demand factors 217 and supply factors 218. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The memory auto tuning server 608 may include additional or fewer modules than those shown in FIG. 7. In embodiments, separate modules may be integrated into a single module. Additionally, or alternatively, a single module may be implemented as multiple modules. Moreover, the quantity of devices and/or networks in the environment is not limited to what is shown in FIG. 7. In practice, the environment may include additional devices and/or networks; fewer devices and/or networks; different devices and/or networks; or differently arranged devices and/or networks than illustrated in FIG. 7.

In FIG. 7, and in accordance with aspects of the invention, the classification and storing tuning module 610 uses a feedback loop between an agent and the environment state module 216 to perform a reinforcement learning algorithm between the agent and the environment state module 216. In particular, by using the reinforcement learning algorithm in FIG. 7, the agent updates a knowledge based on a reward and takes a next action based on the reward. Accordingly, by performing the reinforcement learning algorithm between the agent and the environment state module 216, the classification and storing tuning module 610 improves training of an application classification model and the memory tune action model. In embodiments, the classification and storage tuning module 610 refines the training of the application classification model and the memory tune action model, respectively based on the output of the execution of the workload policies of the at least one workload. In further embodiments, the classification and storage tuning module 610 refines the training of the application classification model and the memory tune action model in response to a determination that the reward of the at least one workload is not 1. The execution module 214 may end the process in response to a determination that the reward of the at least one workload is 1. Thus, the classification and storing tuning model 610 uses the reinforcement algorithm between the agent and the environment state module 216 in addition to the processes described above with respect to the classification module 210 and the storage tuning module 212 in FIG. 2.

In embodiments, the classification and storing tuning module 610 receives at least one workload (e.g., at least one transaction) and classifies the at least one workload (e.g., at least one transaction) for a mixed addressing mode application using an application classification model. In particular, the classification and storing module 610 trains the application classification model for a mixed addressing mode application using at least one of historical profiling data, performance data, an initial model training run, historical data, demand factors, supply factors, information from applications, etc. In embodiments, the classification and storing module 610 uses a computer-implemented classification method to classify the at least one workload. The computer-implemented classification method may comprise classifying using a support vector machine (SVM) algorithm. For example, the classification and storing module 610 receives information from applications (e.g., an initial model training run) and historic profiling data to generate an initial static history data which includes a memory demand, memory supply, response time for training the application classification model and classifies the at least one workload for a mixed addressing mode application using the trained application classification model. Details of the classification and storing tuning module 610 classifying the at least one workload for the mixed addressing mode application are similar to the classification module 210 described in FIG. 2 herein.

In FIG. 7, and in accordance with aspects of the invention, the classification and storing tuning module 610 models a memory tune action model based on the demand factors 217 and the supply factors 218. In particular, the classification and storage tuning module 610 models the memory tune action model based on the workload classification tables and tuning policies. The classification and storage tuning module 610 also includes Class 1 policies, Class 2 policies, Class 3 policies, Class 4 policies, Class 5 policies, Class 6 policies, and/or Class n policies (e.g., n being an integer for the last policy).

In embodiments, the classification and storage tuning module 610 comprises an agent for every class policy. In particular, an agent models a corresponding class policy, is matched to at least one workload, and sends an output to the execution model 214 for tuning a memory and executing workload policies of the mixed addressing mode application. In an example, the classification and storage tuning module 610 comprises a first agent, a second agent, a third agent, a fourth agent, a fifth agent, and a sixth agent which correspond with a Class 1 Policy, a Class 2 Policy, a Class 3 Policy, a Class 4 Policy, a Class 5 Policy, and a Class 6 Policy. In further embodiments, each of the agents model a corresponding class policy based on the workload classification tables and tuning policies. In further embodiments, each of the agents model a corresponding class policy based on the workload classification tables and tuning policies. In addition, each of the agents are matched to the at least one workload based on the workload classification tables (i.e., a workload class) and tuning policies. Then, each of the agents send outputs to the execution model 214 for tuning the memory and executing workload policies of the mixed addressing mode application. In other embodiments, after the classification and storage tuning module 610 models the memory tune action model based on the workload classification tables and tuning policies, the classification and storing tuning module 610 sends outputs from the memory tune action model to the execution module 214 for tuning the memory and executing workload policies of the mixed addressing mode application. Details of the classification and storing tuning module 610 modeling the memory tune action model are similar to the storage tuning module 212 described in FIG. 2 herein.

In FIG. 7, and in accordance with aspects of the invention, the execution module 214 tunes the memory based on the outputs from the memory tune action model in the storage tuning module 212 and executes workload policies of the at least workload of the mixed addressing mode application based on the tuning of the memory. The execution module 214 also performs an evaluation of the execution of the workload policies of the at least one workload of the AMODE application based on the tuning of the memory. In an example, the execution module 214 includes a plurality of transactions (e.g., transaction 1, transaction 2 . . . , transaction n), a runtime library, a system kernel, etc. for tuning the memory and executing and evaluating the workload policies of the at least one workload AMODE application based on the tuning of the memory. After the execution module 214 tunes the memory and executes the workload policies of the at least one workload, the execution module 214 sends the output of the execution to the historical data for refining the application classification model and the memory tune action model of the classification module 210 and the storage tuning module 212, respectively. The execution model 214 evaluates the transaction per second (TPS) for each transaction and the response time of the at least one workload. Details of the evaluation model 214 are similar to the description in FIG. 2.

In FIG. 7, and in accordance with aspects of the invention, the environmental state module 216 receives applications and a service level agreement (SLA) and generates the demand factors 217 and the supply factors 218. For example, the environmental state module 216 generates demand factors 217, such as 31-bit factors, 64-bit factors, co-related factors, priority, etc. based on the applications and the SLA, and sends the demand factors 217 to the classification and storage tuning module 610. In another example, the environmental state module 216 generates supply factors 218, such as a 31-bit virtual memory saturation level, a 64-bit real memory saturation level, etc. based on the applications and the SLA, and sends the supply factors 218 to the classification and storage tuning module 610. Details of the environmental state model 216 are similar to the description in FIG. 2.

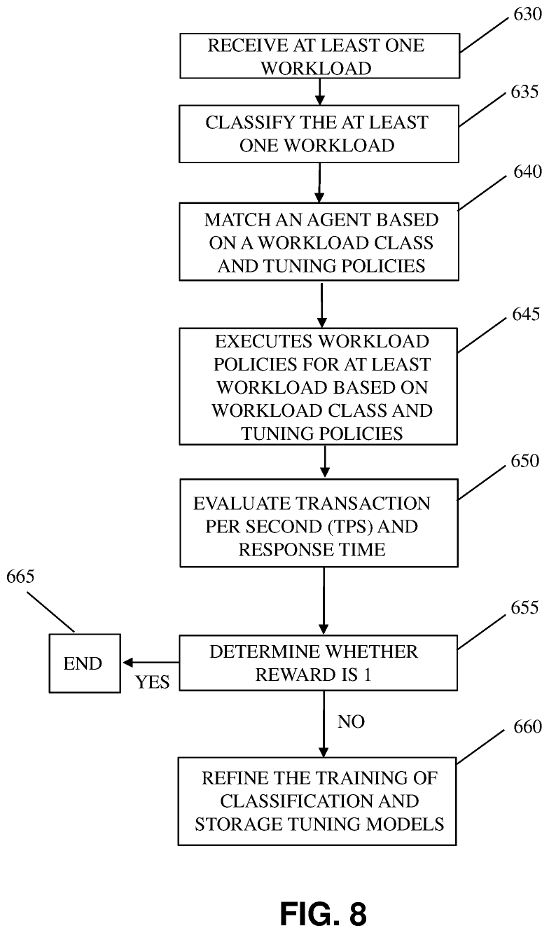

FIG. 8 shows a flowchart of another exemplary method of the memory auto tuning server in accordance with aspects of the present invention. Steps of the method may be carried out in the environment of FIG. 7 and are described with reference to elements depicted in FIG. 7.

At step 630, the system receives, at the classification and storage tuning module 610, at least one workload for a mixed addressing mode application using an application classification model. In embodiments and as described with respect to FIG. 7, the classification and storage tuning module 610 trains the application classification model using at least one of historical profiling data, performance data, an initial model training run, historical data, demand factors, supply factors, information from applications, etc. At step 635, the system classifies, at the classification and storage tuning module 610, the at least one workload for the mixed AMODE application. In embodiments and as described with respect to FIG. 7, the classification and storage tuning module 610 classifies the at least one workload using a support vector machine (SVM) algorithm.

At step 640, the system matches, at the classification and storage tuning module 610, an agent to the at least one workload based on the workload class of the workload classification tables and tuning policies. At step 645, the system executes, at the execution module 214, the workload policies of the at least one workload based on the workload class and tuning policies.

At step 650, the system evaluates, at the execution module 214, a transaction per second (TPS) and response time of the at least one workload. At step 655, the system determines, at the execution module 214, whether a reward of the least one workload is 1.

At step 660, the system refines, at the classification and storage tuning module 610, the training of the application classification model and the memory tune action model, respectively based on the output of the execution of the workload policies of the at least one workload in response to a determination that the reward of the at least one workload is not 1. At step 665, the system ends, at the execution module 214, the process in response to a determination that the reward of the at least one workload is 1.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, at least one workload of a mixed addressing mode application;
classifying, by the processor set, the at least one workload with artificial intelligence (AI) including a support vector machine (SVM) algorithm;
matching, by the processor set, at least one agent to the at least one workload based on a workload class and tuning policies;
executing, by the processor set, workload polices of the at least one workload based on the workload class and the tuning policies;
evaluating, by the processor set, a transaction per second (TPS) and response time of the at least one workload;
calculating, by the processor set, a reward of the at least one workload; and
training a plurality of models based on historical data corresponding to the evaluated TPS, the evaluated response time, and the calculated reward.

2. The computer-implemented method of claim 1, wherein the training the plurality of models comprises:
training an application classification model by further selecting from a group consisting of: historical profiling data, performance data, an initial model training run, demand factors, supply factors, and information from at least one application; and
classifying the at least one workload using the AI including the SVM algorithm and the trained application classification model.

3. The computer-implemented method of claim 1, wherein the training the plurality of models comprises:
training a memory tune action model based on a class policy corresponding to the workload class; and
determining the tuning policies using the trained memory tune action model.

4. The computer-implemented method of claim 3, wherein the class policy corresponding to the workload class comprises demand factors and supply factors of at least one application and a service level agreement (SLA).

5. The computer-implemented method of claim 1, wherein the mixed addressing mode application includes a first bit program and a second bit program which is different from the first bit program.

6. The computer-implemented method of claim 5, wherein the first bit program comprises a 31-bit program.

7. The computer-implemented method of claim 6, wherein the 31-bit program comprises a common business oriented language (COBOL) program.

8. The computer-implemented method of claim 5, wherein the second bit program comprises a 64-bit program.

9. The computer-implemented method of claim 8, wherein the 64-bit program comprises a Java program.

10. The computer-implemented method of claim 1, wherein the at least one agent models a class policy corresponding to the workload class.

11. The computer-implemented method of claim 10, wherein the at least one agent models the class policy corresponding to the workload class by utilizing a reinforcement learning algorithm based on demand factors and supply factors.

12. A computer program product comprising one or more computer readable storage media having program instructions collectively stored on the one or more computer readable storage media, the program instructions executable to:
receive at least one workload of a mixed addressing mode application;
classify the at least one workload using a support vector machine (SVM) algorithm;
match at least one agent to the at least one workload based on a workload class and tuning policies;
execute workload polices of the at least one workload based on the workload class and the tuning policies;
evaluate a transaction per second (TPS) and response time of the at least one workload;
calculate a reward of the at least one workload; and
train a plurality of models based on historical data corresponding to the evaluated TPS, the evaluated response time, and the calculated reward.

13. The computer program product of claim 12, wherein the training the plurality of models comprises:
training an application classification model by further selecting from a group consisting of: historical profiling data, performance data, an initial model training run, demand factors, supply factors, and information from at least one application; and
classifying the at least one workload using the SVM algorithm and the trained application classification model.

14. The computer program product of claim 12, wherein the training the plurality of models comprises:
training a memory tune action model based on a class policy corresponding to the workload class; and
determining the tuning policies based on the trained memory tune action model.

15. The computer program product of claim 12, wherein the mixed addressing mode application includes a first bit program and a second bit program which is different from the first bit program.

16. The computer program product of claim 12, wherein the at least one agent models a class policy corresponding to the workload class.

17. The computer program product of claim 16, wherein the at least one agent models the class policy corresponding to the workload class by utilizing a reinforcement learning algorithm based on demand factors and supply factors.

18. A system comprising:
a processor set, one or more computer readable storage media, and program instructions collectively stored on the one or more computer readable storage media, the program instructions executable to:
receive at least one workload of a mixed addressing mode application;
classify the at least one workload using a support vector machine (SVM) algorithm;
match at least one agent to the at least one workload based on a workload class and tuning policies;
execute workload polices of the at least one workload based on the workload class and the tuning policies;
evaluate a transaction per second (TPS) and response time of the at least one workload;
calculate a reward of the at least one workload; and
train a plurality of models based on historical data corresponding to the evaluated TPS, the evaluated response time, and the calculated reward,
wherein the at least one agent models a class policy corresponding to the workload class by utilizing a reinforcement learning algorithm based on demand factors and supply factors.

19. The system of claim 18, wherein the mixed addressing mode application includes a first bit program and a second bit program which is different from the first bit program.

20. The system of claim 18, wherein the demand factors and the supply factors correspond with at least one application and a service level agreement (SLA).
